(19) United States
(12) Patent Application Publication
(10) Pub. No.: US 2025/0206574 A1
(43) Pub. Date: Jun. 26, 2025

(54) METHOD FOR CONTROLLING A CONVEYOR, CONTROLLING DEVICE, AND CONVEYOR

(71) Applicant: Otis Elevator Company, Farmington, CT (US)

(72) Inventors: Xinwei Gong, Haining (CN); Lifei Cheng, Hangzhou (CN); Zhaoxia Hu, Hangzhou (CN)

(21) Appl. No.: 18/985,602

(22) Filed: Dec. 18, 2024

(30) Foreign Application Priority Data
Dec. 20, 2023 (CN) 202311766592.3

(51) Int. Cl. B66B 29/00; B66B 25/00

(52) U.S. Cl. CPC B66B 29/005; B66B 25/00

(57) ABSTRACT

A method for controlling conveyor devices. The method includes in response to an emergency signal, controlling a conveyor device among conveyor devices associated with a location of an emergency that moves in the same direction as an escape direction to continue moving; and stopping a conveyor device among the conveyor devices associated with the location of the emergency that moves towards a floor where the emergency occurs from moving towards the floor; and in which the conveyor devices associated with the location of the emergency includes a conveyor device with either its conveying entrance or its conveying exit located on the floor where the emergency occurs.

### FOREIGN PRIORITY

This application claims priority to Chinese Patent Application No. 202311766592.3, filed Dec. 20, 2023, and all the benefits accruing therefrom under 35 U.S.C. § 119, the contents of which in its entirety are herein incorporated by reference.

### TECHNICAL FIELD OF INVENTION

The present application relates to a conveyor device, and in particular to technologies for controlling a conveyor device in case of emergency.

### BACKGROUND OF THE INVENTION

When an emergency occurs in a building, such as a fire, people inside the building need to evacuate to the exit of the building as soon as possible. When an emergency occurs in the building, the escalators or elevators in the building usually stop running, and at the same time, the emergency evacuation system inside the building may guide people to evacuate through escape ways.

### SUMMARY OF THE INVENTION

The present application provides a method for controlling conveyor devices, which may comprise: in response to an emergency signal, controlling a conveyor device among conveyor devices associated with a location of an emergency that moves in the same direction as the escape direction to continue moving; and stopping a conveyor device among the conveyor devices associated with the location of the emergency that moves towards a floor where the emergency occurs from moving towards the floor; wherein, the conveyor device associated with the location of the emergency includes a conveyor device with either its conveying entrance or its conveying exit located on the floor where the emergency occurs.

The method, for example, may further comprise: determining a distance of each conveyor device associated with the location of the emergency from the location of the emergency; if there is a conveyor device with a determined distance less than a distance threshold, stopping it from moving; and, if there is a conveyor device with a determined distance greater than the distance threshold and moves in the same direction as the escape direction, controlling the conveyor device to continue moving.

The method, for example, may further comprise: determining a distance from each conveyor device associated with the location of the emergency from the location of the emergency; if there is a conveyor device among the conveyor devices with the determined distance greater than the distance threshold and moving towards the floor where the emergency occurs, controlling it to move in the opposite direction.

The method, for example, may further comprise: outputting a signal indicating a running status of the conveyor device; and/or sending a signal to a control system of the building where the emergency occurs to indicate the conveyor device that still running or stopped; wherein, the running statuses of the conveyor device includes any of going-up, going-down, and stopped.

In the method, for example, the conveyor devices comprise escalators, moving walks, or the both. For the moving walks, the floor where the emergency occurs may mean the location where the emergency occurs.

According to another aspect of the present application, a control apparatus for conveyor devices is also provided, comprising: a communication component for receiving and transmitting signals; a processor configured to in response to an emergency signal received, control a conveyor device among conveyor devices associated with a location of an emergency that is in the same direction as the escape direction to continue moving; and stop a conveyor device among the conveyor devices associated with the location of the emergency that moves towards a floor where the emergency occurs from running towards the floor; wherein, the conveyor devices associated with the location of the emergency includes a conveyor device with either its conveying entrance or its conveying exit located on the floor where the emergency occurs.

In the control apparatus, for example, the processor is further configured to: determine a distance of each conveyor device associated with the location of the emergency from the location of the emergency; if there is a conveyor device with the determined distance less than a distance threshold, stop the conveyor device from moving; and, if there is a conveyor device with the determined distance greater than the distance threshold and moving in the same direction as the escape direction, control the conveyor device to continue moving.

In the control apparatus, for example, the processor is configured to: determine a distance of each conveyor device associated with the location of the emergency from the location of the emergency; and, if there is a conveyor device among the conveyor devices with the determined distance greater than the distance threshold and moving towards the floor where the emergency occurs, control it to move in the opposite direction.

In the control apparatus, for example, the processor is configured to output a signal indicating a running status of a conveyor device; and/or, control the communication component to send a signal to a control system of the building where the emergency occurs to indicate the conveyor device that is still in operation; wherein, the running statuses of the conveyor device can be one of going-up, going-down, and stopped.

A conveyor device is also provided, which is configured to perform the method according to any of the above; or include the control apparatus according to any of the above.

A non-transitory computer storage medium is further provided, with instructions stored thereon, where the method according to any of the above is implemented when the instructions are executed.

### BRIEF DESCRIPTION OF THE DRAWINGS

The embodiments of the present application will be described in detail below in conjunction with the accompanying drawings, so that the present application can be fully understood, where:

FIG. 1 is a schematic diagram of an escalator 10;

FIG. 2 illustrates, as an example, the interaction between a control system of a conveyor device and a control system of a building;

FIG. 3 is a flowchart of a method for controlling a conveyor devices according to some examples of the present application;

FIG. 4 is a flowchart of a method for controlling conveyor devices according to other examples of the present application;

FIG. 5 is a simplified schematic diagram of a fire occurring inside a building, which illustrates the floors and escalators;

FIG. 6 is a flowchart of a method for controlling conveyor devices according to some specific examples of the present application; and

FIG. 7 is a block diagram of a control apparatus for conveyor devices according to some examples of the present application.

### DETAILED DESCRIPTION OF THE INVENTION

To assist those skilled in the art to gain a precise understanding of the subject matter claimed by the present application, the specific embodiments of the present application will be described in detail below in conjunction with the accompanying drawings.

The conveyor devices according to the present application may include escalators, travellators, and other conveyor devices for transporting passengers and/or goods. Wherein, a travellator may also be referred to as a moving walk, and a conveyor device may also be referred to as a conveying device, a conveying system, a conveyor system, a passenger conveyor, a passenger conveyor system, and the like. Although the following embodiments of the present application all use examples of escalators being used as conveyor devices to describe the present application, it should be appreciated, however, that the various examples of a method for controlling a conveyor device and a control apparatus described in conjunction with an escalator in the present application can be applied to other conveyor devices or conveyor systems, such as moving walks.

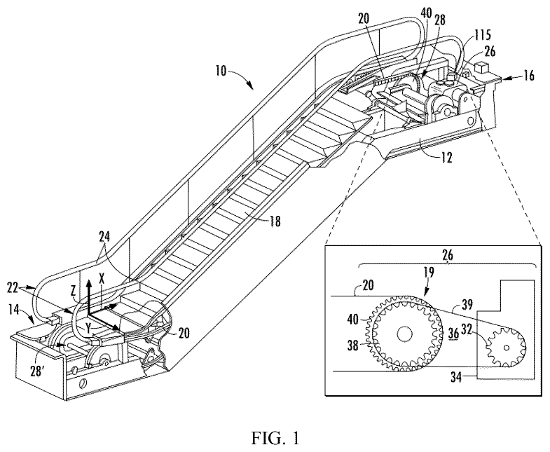

FIG. 1 illustrates an escalator 10. It should become apparent in the ensuing description that the present invention is applicable to other passenger conveyor systems, such as moving walks. The escalator 10 generally includes a truss 12 extending between a lower landing 14 and an upper landing 16. A plurality of sequentially connected steps or tread plates 18 are connected to a step chain 20 and travel through a closed loop path within the truss 12. A pair of balustrades 22 includes moving handrails 24. A drive machine 26, or drive system, is typically located in a machine space 28 under the upper landing 16; however, an additional machine space 28′ can be located under the lower landing 14. The drive machine 26 is configured to drive the tread plates 18 and/or handrails 24 through the step chain 20. The drive machine 26 operates to move the tread plates 18 in a chosen direction at a desired speed under normal operating conditions.

The tread plates 18 make a 180 degree heading change in a turn-around area 19 located under the lower landing 14 and upper landing 16. The tread plates 18 are pivotally attached to the step chain 20 and follow a closed loop path of the step chain 20, running from one landing to the other, and back again.

The drive machine 26 includes a first drive member 32, such as motor output sheave, connected to a drive motor 34 through a belt reduction assembly 36 including a second drive member 38, such as an output sheave, driven by a tension member 39, such as an output belt. The first drive member 32 in some embodiments is a driving member, and the second drive member 38 is a driven member.

As used herein, the first drive member 32 and/or the second drive member 38, in various embodiments, may be any type of rotational device, such as a sheave, pulley, gear, wheel, sprocket, cog, pinion, etc. The tension member 39, in various embodiments, can be configured as a chain, belt, cable, ribbon, band, strip, or any other similar device that operatively connects two elements to provide a driving force from one element to another. For example, the tension member 39 may be any type of interconnecting member that extends between and operatively connects the first drive member 32 and a second drive member 38. In some embodiments, as shown in FIG. 1, the first drive member 32 and the second drive member may provide a belt reduction. For example, first drive member 32 may be approximately 75 mm (2.95 inches) in diameter while the second drive member 38 may be approximately 750 mm (29.53 inches) in diameter. The belt reduction, for example, allows the replacement of sheaves to change the speed for 50 or 60 Hz electrical supply power applications, or different step speeds. However, in other embodiments the second drive member 38 may be substantially similar to the first drive member 32.

As noted, the first drive member 32 is driven by drive motor 34 and thus is configured to drive the tension member 39 and the second drive member 38. In some embodiments, the second drive member 38 may be an idle gear or similar device that is driven by the operative connection between the first drive member 32 and the second drive member 38 by means of tension member 39. The tension member 39 travels around a loop set by the first drive member 32 and the second drive member 38, which hereinafter may be referred to as a small loop. The small loop is provided for driving a larger loop which consists of the step chain 20, and is driven by an output sheave 40, for example. Under normal operating conditions, the tension member 39 and the step chain 20 move in unison, based upon the speed of movement of the first drive member 32 as driven by the drive motor 34.

The escalator 10 also includes a controller 115 that is in electronic communication with the drive motor 34. The controller 115 may be located, as shown, in the machine space 28 of the escalator 10 and is configured to control the operation of the escalator 10. For example, the controller 115 may provide drive signals to the drive motor 34 to control the acceleration, deceleration, stopping, etc. of the tread plates 18 through the step chain 20. The controller 115 may be an electronic controller including a processor and an associated memory comprising computer-executable instructions that, when executed by the processor, cause the processor to perform various operations. The processor may be, but is not limited to, a single-processor or multi-processor system of any of a wide array of possible architectures, including field programmable gate array (FPGA), central processing unit (CPU), application specific integrated circuits (ASIC), digital signal processor (DSP) or graphics processing unit (GPU) hardware arranged homogenously or heterogeneously. The memory may be but is not limited to a random access memory (RAM), read only memory (ROM), or other electronic, optical, magnetic or any other computer readable medium.

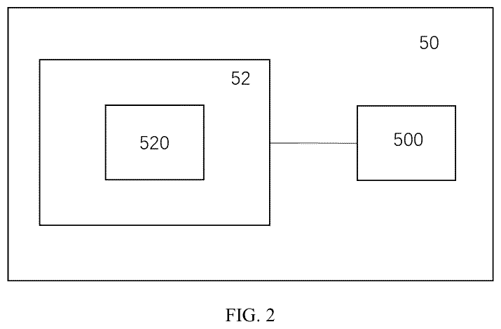

FIG. 2 illustrates, as an example, the interaction between a control system of a conveyor device and a control system of a building. As shown in FIG. 2, a conveyor device 52 is arranged inside a building 50. A control system 520 (e.g., a microprocessor-based controller) of the conveyor device 52 is in communication connection with a control system 500 (e.g., a microprocessor-based controller) of the building 50, such as in wireless communication connection or in cable connection. As an example, the control system 520 is implemented, for example, in the controller of the conveyor device 52 or partially implemented in the controller of the conveyor device 52. The control system 500 is, for example, a system of the building 50 for monitoring emergencies such as fires and implementing evacuation, such as an automatic control system of a building.

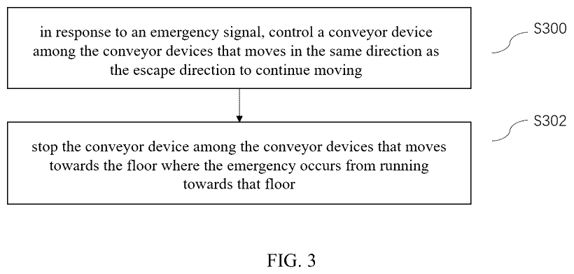

FIG. 3 is a flowchart of a method for controlling conveyor devices according to some examples of the present application. In step S300, a conveyor device among the conveyor devices associated with the location of the emergency that moves in the same direction as the escape direction is controlled to continue moving, in response to an emergency signal. For example, the emergency signal can be issued by the control system of the building where the conveyor devices are located, and the signal may include information indicating the location of the emergency. Alternatively, the emergency signal can be a warning signal triggered by the control system of the building in case of an emergency, in which case the location of the emergency can be further determined. The control system of the building can be preset with escape directions, where the escape directions may be different depending on the location of the emergency. In step S302, the conveyor device among the conveyor devices associated with the location of the emergency that moves towards the floor where the emergency occurs is stopped from moving towards that floor. The conveyor device associated with the location of an emergency includes such conveyor device of which the conveying entrance or conveying exit located at the floor where the emergency occurs. The conveying entrance here refers to the position where objects such as passengers and items being transported board the conveyor device, while the conveying exit refers to the position where objects such as passengers and items being transported leave the conveyor device.

In the event of an emergency, compared to stopping all conveyor devices from moving, keeping the conveyor devices which move in the same direction as the escape direction running is more conducive to the rapid evacuation of the crowd to be evacuated.

The method shown in FIG. 3 can be executed by the control system 520 in FIG. 2. As an alternative, the method can be executed by a controller independent of the control system 520 but capable of communicating with the control system 520. In some cases, the method described in FIG. 3 can be executed by the control system 500 of the building, in which case the control system 500 can directly control the conveyor devices or send control signals to the control system of the conveyor devices.

Referring to both FIGS. 2 and 3, in response to an emergency signal, the control system 520 of the conveyor device 52 determines the escape direction, and keep the conveyor device(s) among the conveyor devices associated with the location of the emergency that moves in the same direction as the escape direction running (step S300). In this example, the emergency signal is issued by the control system 500 of the building 50. Specifically, the control system 500 controls the warning component located in the area where the emergency occurs to issue an emergency signal, which triggers the control system 520 of the conveyor device 52. The control system 520, which receives the emergency signal, can determine the location of the emergency based on the source that the signal is from. The control system 520 of the conveyor device determines the escape direction in response to the emergency signal. As an example, the control system 520 can obtain the escape direction from the control system 500 of the building. After determining the escape direction, the control system 520 determines which conveyor devices among the conveyor devices associated with the location of the emergency are moving in the same direction as the escape direction, so as to allow the conveyor devices moving in the same direction as the escape direction to continue working. Also, in response to the emergency signal, the conveyor device(s) among the conveyor devices associated with the location of the emergency that moves towards the floor where the emergency occurs is stopped from moving towards the floor (step S302).

Here, the conveyor device can be an escalator or a moving walk. For example, the conveyor devices in the building 50 can be escalators, or moving walks, or both. When the conveyor device is a moving walk, the floor where the emergency occurs mentioned in step S302 can be the area or location where the emergency occurs.

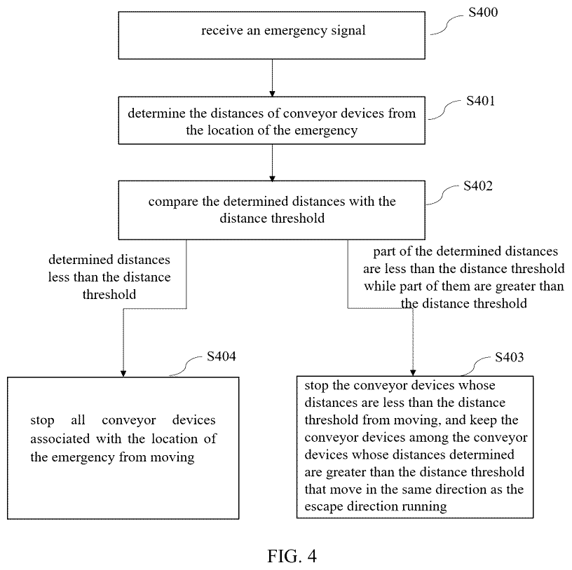

According to some examples of the present application, the method for controlling the running of conveyor devices described in combination with FIG. 3 also comprises determining distance of each of the conveyor devices associated with the location of the emergency from the location of the emergency. FIG. 4 is a flowchart of a method for controlling the running of conveyor devices according to these examples. As shown in FIG. 4, in step S400, an emergency signal is received. In step S401, the distances between the location of the emergency and each of the conveyor devices associated with the location of the emergency are determined. For example, when an emergency occurs in a certain area on the second floor, the signal for indicating the emergency in that area triggers the control system of the conveyor device, and the control system determines the distances of the conveyor devices which are going up or down between the second and lower floors, and going up or down between the second and higher floors from the location of the emergency. In the example, the conveyor devices, which are going up or down between the second and lower floors and are going up or down between the second and higher floors, are the conveyor devices associated with the location of emergency, since their entrances or exits locate the second floor. In step S402, the determined distances each are compared with the distance threshold. The distance threshold is pre-set, which can be set according to different emergencies or can be directly set to a relatively large value to ensure safety. A conveyor device among those associated with the location of the emergency can be considered in a non-safe area if the determined distance of that conveyor device from the location of the emergency is less than the distance threshold. And, a conveyor device among those associated with the location of the emergency can be considered in a safe area if the determined distance of that conveyor device from the location of the emergency is greater than the distance threshold. Then, proceed to step S404 and/or step S403 according to the comparison results from the step S402.

If it is determined in the step S402 that the distances of all conveyor devices associated with the location of the emergency from the location of the emergency are less than the distance threshold, then proceed to step $404. In step S404, conveyor devices associated with the location of the emergency are stopped from moving. If it is determined in step S402 that the distances between part of the conveyor devices associated with the location of the emergency and the location of the emergency are less than the distance threshold, while part of them are greater than the distance threshold, then proceed to step S403. In step S403, the conveyor devices whose distances determined in step S402 are less than the distance threshold are stopped from moving, while the conveyor devices among the conveyor devices whose distances determined are greater than the distance threshold that move in the same direction as the escape direction are kept running. In case all conveyor devices associated with the location of the emergency and the location of the emergency are greater than the distance threshold, at least the ones of said all conveyor devices that move in the same direction as the escape direction are kept running, while the remaining conveyor devices, namely moving in the direction opposite to the escape direction, can be stopped.

According to some scenarios in this example, in step S403, besides stopping the conveyor devices with the determined distances less than the distance threshold from moving, and allowing the conveyor devices among the conveyor devices with the distances determined greater than the distance threshold that move in the same direction as the escape direction to continue moving, it may further comprise: controlling the conveyor devices with the determined distances greater than the distance threshold that move towards the floor where the emergency occurs to move in the opposite direction, i.e., to move towards the escape direction.

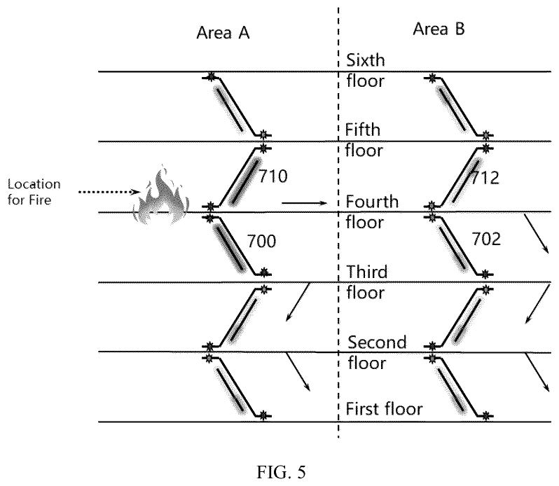

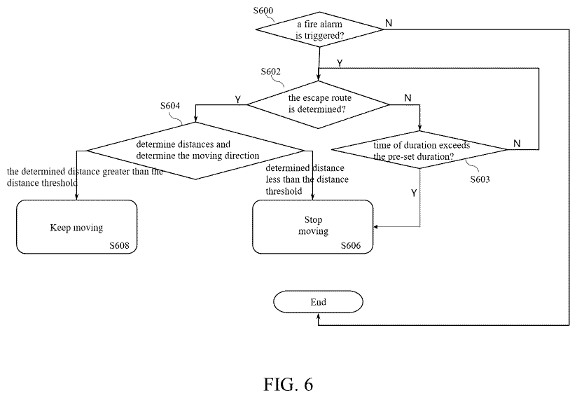

FIG. 5 is a simplified schematic diagram of a fire occurring inside a building, which illustrates the floors and escalators. FIG. 6 is a flowchart of a method for controlling conveyor devices according to some examples of the present application, where the process described in FIG. 6 may be executed, for example, by the control system 520 shown in FIG. 2.

Referring to FIGS. 5, 6, and 2 at the same time, in this example, the conveyor devices are escalators, and the building is a building comprising multiple floors, such as 6 floors from the first floor to the sixth floor. The building 50 is schematically divided into two areas, i.e., Area A and Area B. In the example, each floor of the building 50 is provided with going-up and going-down escalators to other floors. For convenience, in FIG. 5, the going-up escalators are arranged in Area A, and the going-down escalators are arranged in Area B. It should be noted that FIG. 5 is only an example. In the actual applications, some floors of the building 50 may be configured with two sets of escalators, while some floors may be configured with one set, and so on.

When the control system 500 of the building 50 detects a fire in part of Area A on the fourth floor, it immediately triggers a fire alarm signal. Accordingly, the control system 520 of the escalator (i.e. conveyor device) 52 determines that the fire alarm signal has been triggered, thus proceeding from step S600 of determining whether the fire alarm signal has been triggered to step S602. In step S602, it is to be determined whether the control system 520 has determined the escape direction. The determination of the escape direction can be obtained from the control system 500 of the building 50 by the control system 520. Alternatively, the determination of the escape direction can be determined based on the escape broadcasting of the control system 500 of the building 50. In the example shown in FIG. 5, the escape direction is downward, and it can be determined based on the area where the fire occurs (area A on the fourth floor) that the escape direction for this floor should be towards the direction away from area A. With the escape direction determined, proceed to step S604. In step S604, the control system 520 determines the distances of the conveyor devices associated with the location of the fire from the location of the fire, and determines whether the conveyor devices are moving in the same direction as the escape direction. In FIG. 5, the conveyor devices associated with the fire include escalators 700 and 702 running between the third and fourth floors, and escalators 710 and 712 running between the fourth and fifth floors.

The control system 520 determines the distance of each of the escalators 700, 702, 710, and 712 from the location of the fire. Here, the distance threshold is, for example, 20 meters. According to the determinations of step S604, proceed to steps S606 and S608 respectively. When the control system 520 determines that the distances of the escalators 700 and 710 associated with the location of the fire from the location of the fire are less than the distance threshold, it is unsafe to run in this area. Therefore, proceed to step S606. In step 606, the escalators are controlled to stop moving. For this example, the escalators 700 and 710 are stopped from moving at step 606. When the control system 520 determines that the distances of the escalators 702 and 712 associated with the location of the fire from the location of the fire are greater than the distance threshold, and the moving direction of escalator 702 is from the fourth floor to the third floor, which is the same as the escape direction, then proceed to step S608, i.e., the control system 520 controls the escalator 702 to continue moving. As for the escalator 712, it can be stopped. Or, the escalator 712 can be controlled to move in the same way as the escape direction.

Return to step S600. If the fire alarm is not triggered, it ends and the method is not executed. In addition, if in step S602 the control system 502 has not determined the escape direction, proceed to step S603 to determine whether the time for determining the escape direction has reached a preset duration. If so, proceed to step S606 and in step 606, stop the escalators from moving; otherwise, return to step S602.

According to some examples of the present application, for conveyor devices that are not associated with the location of emergency, such as the escalators running between the first and second floors, between the second and third floors, and between the fifth and sixth floors in this example, the control system 520 can control them to run in the escape direction, in which case the conveyor devices that were running upwards may be adjusted to run downwards.

According to various examples of the method for controlling the running of conveyor devices according to the present application, they each may further include outputting signals indicating the running status of the conveyor devices. For example, by outputting signals, using an existing display component of escalators, whether the escalators are running upwards or downwards, or are stopped, people can be informed of the running status in a timely manner.

According to various examples of the method for controlling the running of conveyor devices according to the present application, in other scenarios, the method may further include sending a signal to the control system of the building where the emergency occurs so as to indicate which conveyor devices are still in operation. For example, in the example shown in FIG. 5, the control system 520 can send a signal to the control system 500 of the building 50, indicating the escalators that are currently stopped or are still in operation. The control system 500 of the building 50 can broadcast based on this to inform the crowd to be evacuated, thereby facilitating rapid and orderly evacuation.

According to some examples of the present application, the method for controlling the running of conveyor devices described herein may further include outputting the escape direction in lighting, voice, etc., which may be executed by the control system of the building. The method may also include outputting the running status of the conveyor device and suggesting escape directions in voice, which can be achieved, for example, by the control system of the conveyor device.

In addition, in conjunction with the examples described in FIGS. 2 to 6, in some scenarios, the control system 520 may be configured or partially configured in the controller 115 of the escalator 10 shown in FIG. 1, or may be in communication connection with it. For example, the control system 520 is implemented as a software module by program instructions, where the entire software module is integrated into the controller 115 shown in FIG. 1, or part of the sub-modules of the software module are implemented in the controller 115. Alternatively, the control system 520 is implemented through program instructions in hardware such as central processing units (CPUs), specialized integrated circuits (ASICs), digital signal processors (DSPs), or graphics processing units (GPUs), and can be in communication connection with the controller 115.

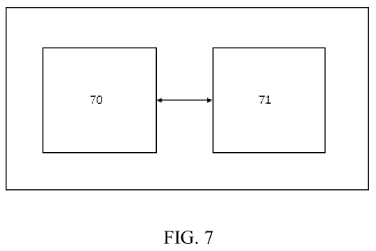

FIG. 7 is a block diagram of a control apparatus for conveyor devices according to examples of the present application. As shown in FIG. 7, the control apparatus comprises a communication component 70 and a processor 71. The communication component 70 (e.g., a network interface card) is used for receiving and transmitting signals. The processor 71 (e.g., a microprocessor) is configured to, in response to the emergency signal received, control the conveyor device of the conveyor devices associated with the location of the emergency that moves in the same direction as the escape direction to continue moving, and controls the conveyor device of the conveyor devices associated with the location of the emergency that moves towards the floor where the emergency occurs to stop moving towards the floor. The conveyor device associated with the location of the emergency includes a conveyor device with either its conveying entrance or its conveying exit located on the floor where the emergency occurs.

According to the control apparatus shown in FIG. 7, it can be used to execute any of the exemplary control method described above with reference to FIGS. 3, 4, and 6. For example, the processor 71 can be configured to perform steps in the above examples of the method except for sending and receiving signals, such as steps S300 and S302 (FIG. 3), steps S401 to S406 (FIG. 4), and steps S602 to S608 (FIG. 6).

According to the various examples of a control apparatus for a conveyor device according to the present application, the processor can also be configured to generate signals indicating the running status of the conveyor device, for example, signals of displaying whether the conveyor device moving upwards or downwards, or is stopped.

The signals can be displayed through the existing display components of the conveyor device, so that people can be timely informed of the running status of the escalator.

According to the various examples of a control apparatus for a conveyor device according to the present application, in other scenarios, the processor can also be configured to generate signals used for indicating the conveyor devices that are still in operation and control the communication components to send the signals to the control system of the building where the emergency occurs. This helps the control system of the building to output signals through broadcasting or other means so that the crowd to be evacuated can be informed of which conveyor devices are still in operation.

According to some examples of the present application, the control apparatus for a conveyor device described herein may also comprise outputting the running status of the conveyor device and suggesting escape directions through voice, which can be implemented, for example, by the control system of the conveyor device.

In some examples, the control apparatus shown in FIG. 7 can be implemented in the controller 115 of the escalator shown in FIG. 1. In this case, the portion of the controller 115 used for transmitting signals can be used as the communication component 70 of the control apparatus.

According to an example of the present application, a control system for a conveyor device is also provided. The control system is configured to execute any of the examples of the method for controlling the running of the conveyor device described herein; or, to include any example of the control apparatus for a conveyor device.

According to an example of the present application, a conveyor device is further provided. The conveyor device is configured to execute any of the examples of the method for controlling the running of the conveyor device described herein; or, to include any example of the control apparatus for a conveyor device. The conveyor device is, for example, an escalator.

A non-transitory computer storage medium is still further provided, with instructions stored thereon, where when the instructions are executed, any of the methods described above is implemented.

The conveyor devices described in the various examples of the present application can be, for example, escalators, moving walks, or include the both.

In the absence of contradiction or conflict, the technical features in the examples described herein can be combined with each other to form embodiments not described herein, where these embodiments should also fall within the scope of the present application.

Although specific embodiments of the present application have been shown and described in detail to illustrate the principles of the present application, it should be appreciated, however, that the present application may be implemented in other ways without departing from such principles.

What is claimed is:

1. A method for controlling conveyor devices, comprising:
in response to an emergency signal, controlling a conveyor device among conveyor devices associated with a location of an emergency that moves in the same direction as an escape direction to continue moving; and stopping a conveyor device among the conveyor devices associated with the location of the emergency that moves towards a floor where the emergency occurs from moving towards the floor;
wherein, the conveyor devices associated with the location of the emergency includes a conveyor device with either its conveying entrance or its conveying exit located on the floor where the emergency occurs.

2. The method according to claim 1, further comprising:
determining a distance of each conveyor device associated with the location of the emergency from the location of the emergency;
if there is a conveyor device with the determined distance less than a distance threshold, stopping it from moving; and, if there is a conveyor device with the determined distance greater than the distance threshold and moving in the same direction as the escape direction, controlling the conveyor device to continue moving.

3. The method according to claim 1, further comprising:
determining a distance of each conveyor device associated with the location of the emergency from the location of the emergency;
if there is a conveyor device among the conveyor devices with the determined distance greater than the distance threshold and moving towards the floor where the emergency occurs, controlling the conveyor device to move in an opposite direction.

4. The method according to claim 1, further comprising:
outputting a signal indicating a running status of the conveyor device; and/or
sending a signal to a control system of the building where the emergency occurs to indicate the conveyor device still running or stopped;
wherein, the running status is one of going-up, going-down, and stopped.

5. The method according to claim 1, wherein the conveyor devices includes escalators and/or moving walks, in which for the moving walks, the floor where the emergency occurs is the location where the emergency occurs.

6. A control apparatus for conveyor devices, comprising:
a communication component for receiving and transmitting signals;
a processor configured to, in response to an emergency signal received, control a conveyor device among conveyor devices associated with a location of an emergency that moves in the same direction as an escape direction to continue moving; and stop a conveyor device among the conveyor devices associated with the location of the emergency that moves towards a floor where the emergency occurs from moving towards the floor;
wherein, the conveyor devices associated with the location of the emergency includes a conveyor device with either its conveying entrance or its conveying exit located on the floor where the emergency occurs.

7. The control apparatus according to claim 6, wherein the processor is further configured to:
determine a distance of each conveyor device associated with the location of the emergency from the location of the emergency;
if there is a conveyor device with the determined distance less than a distance threshold, stop the conveyor device from moving; and, if there is a conveyor device with the determined distance greater than the distance threshold and moving in the same direction as the escape direction, control the conveyor device to continue moving.

8. The control apparatus according to claim 6, wherein the processor is further configured to:
determine a distance of each conveyor device associated with the location of the emergency from the location of the emergency; and
if there is a conveyor device among the conveyor devices with the determined distance greater than the distance threshold and moving towards the floor where the emergency occurs, control the conveyor device to move in an opposite direction.

9. The control apparatus according to claim 6, wherein the processor is further configured to:
generate a signal indicating a running status of a conveyor device; and/or control the communication component to send a signal to a control system of the building where the emergency occurs to indicate the conveyor device still in running;
wherein, the running status is one of going-up, going-down, and stopped.

10. The control apparatus according to claim 6, wherein the conveyor device includes escalators and/or moving walks, where for the moving walks, the floor where the emergency occurs is the location where the emergency occurs.

11. A conveyor device, wherein the conveyor device is configured to perform the method according to claim 1.

12. A non-transitory computer storage medium, with instructions stored thereon, where the method according to claim 1 is implemented when the instructions are executed.
